(19) United States
(12) Patent Application Publication
(10) Pub. No.: US 2021/0403350 A1
(43) Pub. Date: Dec. 30, 2021

(54) WORKING ELECTRODE, SYSTEM AND METHOD FOR THE ELECTROCHEMICAL REMEDIATION OF A METAL SPECIES

(71) Applicant: The Board of Trustees of the University of Illinois, Urbana, IL (US)

(72) Inventors: Xiao Su, Champaign, IL (US); Riccardo Candeago, Urbana, IL (US)

(21) Appl. No.: 17/356,873

(22) Filed: Jun. 24, 2021

Related U.S. Application Data
(60) Provisional application No. 63/043,909, filed on Jun. 25, 2020.

(51) Int. Cl. C02F 1/461; C02F 1/467

(52) U.S. Cl. CPC C02F 1/46109; C02F 2101/20; C02F 2001/46138; C02F 1/4672

(57) ABSTRACT

A method for the electrochemical remediation of a metal species comprises flowing a contaminated solution comprising a metal species to be removed through an electrochemical cell that includes a working electrode and a counter electrode spaced apart from the working electrode. The working electrode comprises a conductive substrate or current collector with a polymeric coating thereon, where the polymeric coating comprises a semiconducting or redox-active polymer. A reducing potential is applied to the electrochemical cell, thereby inducing the metal species from the contaminated solution to deposit onto the working electrode. After depositing the metal species, a recovery solution is flowed through the electrochemical cell. An oxidizing potential is applied to the electrochemical cell, thereby stripping the metal species from the working electrode and recovering the metal species in the recovery solution.

### RELATED APPLICATION

The present patent document claims the benefit of priority under 35 U.S.C 119(e) to U.S. Provisional Patent Application No. 63/043,909, which was filed on Jun. 25, 2020, and is hereby incorporated by reference in its entirety.

### TECHNICAL FIELD

The present disclosure is related generally to remediation and separation of metal species from waste streams and more particularly to electrochemical remediation and separation.

### BACKGROUND

Heavy metal pollution in water is an urgent global issue: heavy metals are not biodegradable, tend to accumulate in living organisms and have long lasting negative health effects. Among all the heavy metals, exposure to lead, cadmium, mercury and arsenic is believed to be most threatening for human health. Mercury (Hg) affects the nervous system and the kidneys and its removal from potable water is of primary concern.

Mercury occurs in the elemental (Hg⁰), inorganic (e.g. mercuric (Hg²⁺) and mercurous (Hg₂²⁺) salts), and organic form (e.g. methylmercury); in marine and terrestrial environments, Hg is present mainly as Hg²⁺ complexes with inorganic or organic nucleophilic ligands. In addition, atmospheric Hg is deposited chiefly as divalent mercury (Hg(II)) in watersheds and lake surfaces. Examples of point source Hg pollution include the chlor-alkali process, poly(vinyl chloride) production via calcium carbide method and pharmaceutical wastewater; industrial wastewaters feature broad Hg concentrations (10 μg L⁻¹ to 10 mg L⁻¹). The U.S. Environmental Protection Agency (EPA) set the maximum contaminant level of Hg in potable water to 2 μg L⁻¹ and World Health Organization (WHO) established the maximum allowable level of inorganic mercury in drinking water to 6 μg L⁻¹.

There are various heavy metal remediation techniques, which include both physical and chemical methods. Traditional heavy metals remediation techniques pose serious challenges in that they are energy intensive, require large quantities of chemicals and show an incomplete removal of low concentrated pollutants. Adsorption appears to be one of the best solutions, but it has dire drawbacks such as the adsorbent regeneration and the formation of secondary pollution, up-scaling and material cost. Minimizing secondary pollution and added chemicals are key factors in the actual implementation and cost containment of remediation techniques.

### BRIEF SUMMARY

Described herein is an electrochemical method for the reversible removal of metal species such as mercury from wastewater and other aqueous solutions using a semiconducting or redox-active polymer. Also described are a working electrode and system for electrochemical remediation of a metal species that exploit the semiconducting or redox-active polymer.

The working electrode for the electrochemical remediation of a metal species includes a conductive substrate and a polymeric coating comprising a semiconducting or redox-active polymer on the conductive substrate.

A system for the electrochemical remediation of a metal species includes: an electrochemical cell comprising the working electrode described above and a counter electrode spaced apart from the working electrode; a power supply electrically connected to the working and counter electrodes; and a pump for flowing a contaminated solution and then a recovery solution through the electrochemical cell.

A method for the electrochemical remediation of a metal species comprises flowing a contaminated solution comprising a metal species to be removed through an electrochemical cell that includes a working electrode and a counter electrode spaced apart from the working electrode. The working electrode comprises a current collector (or conductive substrate) with a polymeric coating thereon, where the polymeric coating comprises a semiconducting or redox-active polymer. A reducing potential is applied to the electrochemical cell, thereby inducing the metal species from the contaminated solution to deposit onto the working electrode. After depositing the metal species, a recovery solution is flowed through the electrochemical cell. An oxidizing potential is applied to the electrochemical cell, thereby stripping the metal species from the working electrode and recovering the metal species in the recovery solution.

### BRIEF DESCRIPTION OF THE DRAWINGS

FIGS. 1A-1D provide schematic representations of the system and method for electrochemical remediation of a metal species.

FIGS. 2A and 2B show removal efficiency for various electrode materials after 15 minutes and 1 hour, respectively.

FIG. 3A shows the effect of applied potential and Hg concentration (200 mg L⁻¹, 10 mg L⁻¹, 1 mg L⁻¹) on removal efficiency using a P3HT-CNT/Ti electrode, where electrodeposition takes place for 1 hour in 5 mL of Hg(II)+20 mM KNO₃, and the electrode area is 2 cm².

FIG. 3B shows electrodeposition kinetics obtained via chronoamperometry for electrodeposition in 15 mL of 200 mg L⁻¹ (1 mM) Hg(II)₊20 mM KNO₃, with an electrode area of 2 cm².

FIG. 3C shows removal of Hg under 20 mM KNO₃ and municipal secondary wastewater effluent solution (obtained from Urbana-Champaign Sanitary District) spiked with 85-90 ppb Hg, after application of −1.0 V vs. Ag/AgCl for 5 h.

FIG. 4 shows regeneration efficiency for various electrode materials for electrodeposition for 0.5 h in 200 mg L⁻¹ (1 mM) Hg(II)+20 mM KNO₃ at −1.0 V vs. Ag/AgCl, followed by +1.5 V vs. Ag/AgCl for 0.5 h for releasing (stripping) deposited mercury into 20 mM KNO₃ electrolyte.

FIG. 5 shows regeneration efficiency as a function of time for a P3HT-CNT/Ti electrode at +2.0 V vs. Ag/AgCl.

FIG. 6 shows regeneration efficiency for various electrode materials in 1.1 M HNO₃ electrolyte, where regeneration is achieved via linear scan voltammetry with initial potential +0.25 V vs. Ag/AgCl, final potential +1.50 V vs. Ag/AgCl, scan rate=250 mV s⁻¹, and 300 rpm stirring.

FIGS. 7A-7D show cyclic voltammetry for P3HT-CNT/Ti and bare Ti electrodes for 200 mg L⁻¹ Hg(II)+20 mM KNO₃, 10 cycles, with a scan rate of 50 mV s⁻¹, where the inset shows detail of the oxidation peak on the Ti electrode.

FIG. 7B shows details of the cathodic current from the 3^{rd} cycle of the cyclic voltammetry in FIG. 7A.

FIG. 7C shows cyclic voltammetry for the titanium electrode over a broad potential range.

FIG. 7D shows cyclic voltammetry for the P3HT-CNT/Ti electrode over a broad potential range.

FIG. 8A shows cyclic voltammetry of bare Ti electrodes in 20 mM KNO₃ electrolyte and in 20 mM KNO₃+200 mg L⁻¹(1 mM) Hg(II), with a scan rate of 50 mV s⁻¹, and where only the 3^{rd} cycle is reported.

FIG. 8B shows cyclic voltammetry of P3HT-CNT/Ti electrodes in 20 mM KNO₃ electrolyte and 20 mM KNO₃+200 mg L⁻¹ (1 mM) Hg(II), with a scan rate of 50 mV s⁻¹, and where only the 3^{rd} cycle is reported.

FIG. 8C shows ln(1−F) versus time for the bare Ti electrodes and the P3HT-CNT/Ti electrode.

FIG. 8D shows normalized peak anodic current over 10 cycles for the bare Ti electrodes and the P3HT-CNT/Ti electrodes.

FIG. 9A shows Coulombic efficiency over the working electrode potential for 1, 10, 200 mg L⁻¹ Hg(II) concentration for Hg(II) electrodeposition for a P3HT-CNT/Ti electrode.

FIG. 9B shows specific energy over the working electrode potential for 1, 10, 200 mg L⁻¹ Hg(II) concentration for Hg(II) electrodeposition for a P3HT-CNT/Ti electrode.

FIG. 9C shows electrodeposition kinetics and total energy consumption during electroplating for a P3HT-CNT/Ti electrode (2 cm²), where the inset shows specific energy over time.

FIG. 9D shows specific energy for electrodeposition at −1.0 V vs. Ag/AgCl with 1 mM Hg(II) and for stripping at +2.0 V vs. Ag/AgCl in 20 mM KNO₃, in a comparison of bare Ti vs. P3HT-CNT/Ti electrodes.

FIG. 10A shows Coulombic efficiency over Hg(II) concentration for P3HT-CNT/Ti electrodes with −1 V vs. Ag/AgCl applied potential.

FIG. 10B shows specific energy over Hg(II) concentration for P3HT-CNT/Ti electrodes with −1 V vs. Ag/AgCl applied potential.

### DETAILED DESCRIPTION

It is recognized that an electrochemical approach to heavy metal remediation may offer major advantages compared to traditional techniques: no need of added chemicals for adsorption and recovery, fast adsorptions and desorptions, high selectivity, prolonged cyclability of the electrodes, easy scale-up, and implementation in continuous flow processing of waste or drinkable water. Accordingly, described herein is a new electrochemical method for the reversible removal of metal species such as mercury from aqueous solutions using a semiconducting or redox-active polymer. This approach constitutes the first proposal of employing such polymers for the fast adsorption and high regeneration of the adsorbent. The method has high ion-selectivity toward the metal species even in very small amounts (e.g., ppb-range) and is efficient in many different electrolyte conditions. In addition, the electrochemical technique requires no added chemicals and generates virtually no secondary waste. Experiments described herein show that electro-responsive polymers can form a modular platform for efficient and reversible heavy metal removal, with promising applications for water purification and environmental remediation. The remediation method has commercial application in chemical manufacturing separation, wastewater treatment plants, water purification devices, and industrial oil/gas separation technologies.

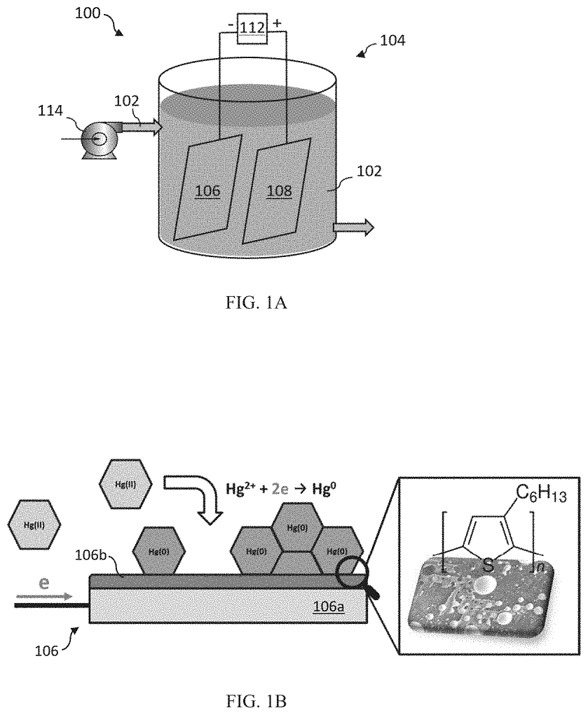

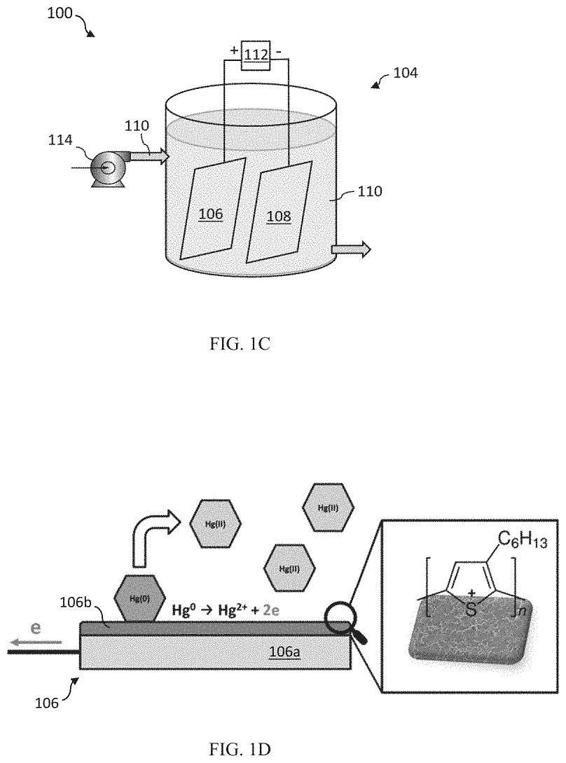

The new method for the electrochemical remediation of a metal species may be understood in reference to FIGS. 1A-1D, which are not to scale and are intended as schematic representations of the system and method. Referring to FIG. 1A, the method includes flowing a contaminated solution (e.g., wastewater) 102 comprising a metal species to be removed through an electrochemical cell 104. The electrochemical cell 104 includes a working electrode 106 comprising a conductive substrate (or “current collector”) 106a with a polymeric coating 106b thereon, and a counter electrode 108 spaced apart from the working electrode 106. The polymeric coating 106b comprises a semiconducting or redox-active polymer and may further include a conductive additive, such as carbon particles or carbon nanotubes. A reducing potential is applied to the electrochemical cell 104, thereby inducing the metal species from the contaminated solution 102 to deposit onto the working electrode 106, as illustrated in FIG. 1B. In this example, the metal species is shown to be mercury (Hg) and the polymer coating may comprise poly(3-hexylthiophene-2,5-diyl) (P3HT) and optionally a conductive additive. The conductive substrate or current collector 106a of the working electrode 106 may comprise titanium, stainless steel, conductive carbon, or another electrically conducting material. The conductive substrate 106a may take the form of a mesh or a felt.

In a next step, the metal species may be desorbed from the working electrode 106 and recovered in a recovery solution. Referring to FIG. 1C, a recovery solution 110 is flowed through the electrochemical cell 104, and an oxidizing potential is applied to the electrochemical cell 104. Accordingly, the metal species is stripped from the working electrode 106, as illustrated in FIG. 1D, and recovered in the recovery solution 110. The method relies on the modulation of heavy metal plating enabled by the semiconducting or redox-active polymer of the polymeric coating 106b, which may increase the kinetics and efficiency of desorption, as discussed below, making the electrosorption technology highly reusable.

The semiconducting or redox-active polymer may comprise poly(3-hexylthiophene-2,5-diyl) (P3HT), poly(vinyl)ferrocene (PVF), poly-TEMPO-methacrylate (PTMA), polyaniline (PANI), poly(3,4-ethylenedioxy thiophene) (PEDOT), polythiophene (PT), poly(3,4-propylenedioxy thiophene) (PProDOT), PEDOT:poly(4-styrene sulfonate) (PEDOT:PSS), polypyrrole (PPy), polyacetylene (PA), poly(indole) (PI), and/or poly(p-phenylene) (P-p-P). P3HT can be oxidatively doped via potential control, introducing polarons and bipolarons (referred as P3HT⁺); oxidizing P3HT corresponds to increasing the hole density and modifying the energetic distribution of charge carriers across the polymer, eventually making P3HT conductive and catalytically active for oxidation reactions. Redox-active polymers may feature redox-active units that can undergo an electron transfer process to become oxidized or reduced, and as a result may serve as both selective adsorbents or catalysts. Semiconducting polymers may be able to conduct electrons across their backbone, often having metallic or semiconductive type properties, and are often conjugated polymers. As indicated above, the polymeric coating 106b may include a conductive additive, such as carbon particles, carbon nanotubes, e.g., multiwalled carbon nanotubes and/or single-walled carbon nanotubes, or another electrically conductive material. The polymeric coating 106b may be formed by dip-coating the conductive substrate 106a in a suspension comprising the semiconducting or redox-active polymer and optionally the carbon nanotubes or other conductive additive.

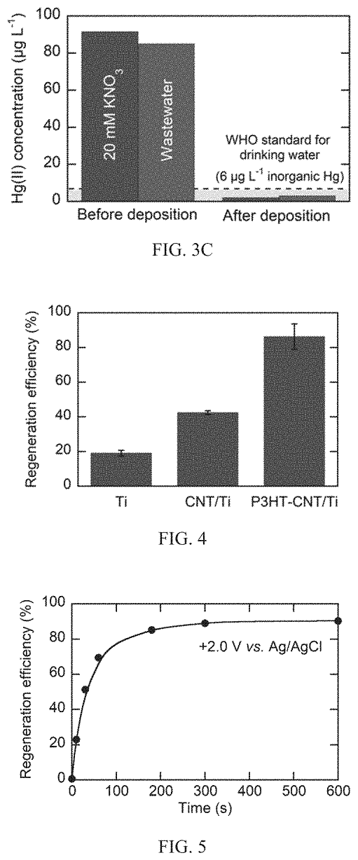

Typically, the reducing potential applied to the electrochemical cell 104 is −0.2 V vs. Ag/AgCl or less, where Ag/AgCl refers to a reference electrode in the electrochemical cell 104. This can be seen in FIG. 3A, which is discussed further below and which shows how the removal efficiency (%) depends on the potential applied to the electrochemical cell 104. As shown, a potential of −0.2 V vs. Ag/AgCl satisfactorily covers all situations for mercury, and may be suitable for other metal species also, possibly with some variations. At least about 96% of the metal species in the contaminated solution 102 may be deposited onto the working electrode 106, corresponding to a removal efficiency of at least about 96%. The deposition of the metal species may occur within about 60 minutes of applying the reducing potential. After applying the reducing potential and depositing the metal species on the working electrode 106, the contaminated solution 102 may contain the metal species (e.g., Hg) at a concentration of less than 6 μg L⁻¹ and as low as 3 μg L⁻¹.

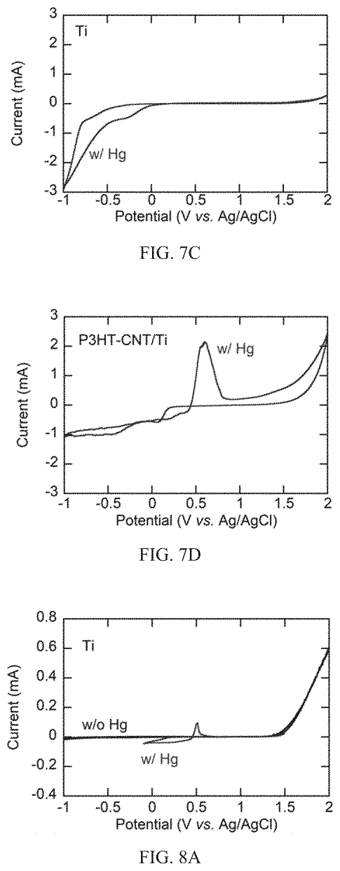

Typically, the oxidizing potential applied to the electrochemical cell 104 for release of the adsorbed metal species is at least about +0.4 V vs. Ag/AgCl, where Ag/AgCl refers to a reference electrode in the electrochemical cell 104. FIGS. 4 and 5, which are discussed further below, show that mercury may be released using higher potentials (e.g., 1.5 and 2.0 V vs. Ag/AgCl). However, the cyclic voltammetry in FIG. 7A show that for potentials >0.4 V vs. Ag/AgCl, an anodic current that allows the release of mercury is attained. This potential may be suitable for other metal species also, possibly with some variations. At least about 80% of the metal species deposited on the working electrode 106 may be released in the recovery solution 110, corresponding to a release or regeneration efficiency of at least about 80%. The stripping of the metal species from the working electrode 106 may occur within about 30 minutes of applying the oxidizing potential. As will be shown in the examples below, working electrodes 106 comprising the semiconducting polymer P3HT and carbon nanotubes coated on a metal substrate may offer a drastically improved stripping performance in comparison with bare metal electrodes.

The contaminated solution 102 may be an aqueous solution which optionally comprises a salt selected from the group consisting of KNO₃, NaCO₃, NaClO₄, and NaCl. The recovery solution 110 may be an aqueous or organic solution optionally comprising a salt selected from the group consisting of KNO₃, NaCO₃, NaClO₄, and NaCl. Preferably, the recovery solution 110 does not include an acid. The metal species to be removed from the contaminated solution 102 may comprise Ag, Al, Au, Cd, Cu, Fe, Hg, Mg, Ni, Pb, Pt, Sn, and/or Zn. Polluting metals such as Pb, Cd and Cu are known to form an amalgam with Hg. The remediation method may thus be effective in removing multiple heavy metals from a single contaminated solution 102. Beneficially, due to the high regeneration efficiency, the working electrode 106 may be reused multiple times.

A system 100 for the electrochemical remediation of a metal species is also described in this disclosure. Referring again to FIGS. 1A-1D, the system 100 may include: an electrochemical cell 104 comprising the working electrode 106 described above and a counter electrode 108 spaced apart from the working electrode 106; a power supply 112 electrically connected to the working and counter electrodes 106,108; and a pump 114 for flowing a contaminated solution 102 (FIG. 1A) and then a recovery solution 110 (FIG. 1C) through the electrochemical cell 104. The counter electrode 108 may comprise a metal, carbon, crystalline material, and/or a polymer, and the electrochemical cell 104 may further comprise a membrane between the working electrode 106 and the counter electrode 108. For some applications, the electrochemical cell 104 may comprise multiple pairs of the working electrode 106 and the counter electrode 108 arranged in a stack.

A proof-of-concept investigation of the inventive electrochemical method, which in this example relies on the modulation of mercury plating using a functional sulphur-containing semiconducting polymer, is described below. In summary, mercury is removed via electrodeposition on a working electrode 106 that exhibits high removal efficiencies (>96%) with real wastewater matrices and enables a final concentration of mercury as low as 3 μg L⁻¹. In this example, the working electrode 106 includes a semiconducting polymer coating 106b comprising poly(3-hexylthiophene-2,5-diyl) (P3HT) with carbon nanotubes (CNTs) dispersed therein on a titanium (Ti) current collector (“P3HT-CNT/Ti”). The semiconducting polymer P3HT together with the CNTs offer an improved stripping performance in comparison with bare titanium electrodes. During release, electrodeposited mercury may be reversibly stripped with fast kinetics in a non-acid electrolyte via potential control, allowing the P3HT-CNT/Ti working electrode 106 to be regenerated. In-situ optical microscopy confirms the rapid, reversible nature of the electrodeposition/stripping process occurring at the P3HT-CNT/Ti interface, indicating the key role of the polymer redox-process in mediating the mercury phase transition. Moreover, an estimation of energy consumption highlights a three-fold enhancement in energy efficiency with the use of the P3HT-CNT/Ti electrode compared to the bare titanium substrate.

### EXAMPLES

Introduction

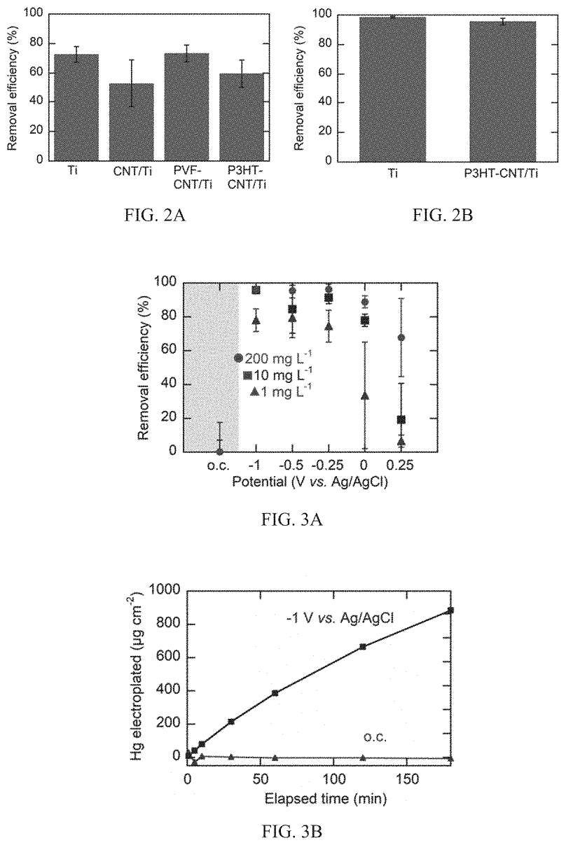

Several working electrodes are tested to evaluate the performance of Hg removal enabled by electrodeposition. The conductive substrate Ti shows the best removal efficiency among materials tested; over 70% and 95% removal after 15 min and 1 h, respectively, as shown in FIGS. 2A and 2B. A critical problem of Ti is its irreversibility, however, which hinders regeneration of the clean surface. Therefore, a focus of this study is to identify material(s) that allow for both effective removal (deposition) and reversible release (stripping) modulated by electrical control.

To highlight the performance of Hg removal using a P3HT-functionalized (or “coated”) surface, the removal capability of P3HT-CNT/Ti to deposit Hg electrochemically is first confirmed, and then an investigation of how P3HT-functionalized Ti overcomes the limitation of Ti and provides better stripping is undertaken using various characterization techniques.

Hg Removal by Electrodeposition

P3HT-coated electrodes are prepared via dip-coating in a suspension of P3HT and multiwalled carbon nanotubes using titanium (Ti) mesh as substrate (P3HT-CNT/Ti). The P3HT-CNT/Ti working electrodes show a homogenous and nanoporous morphology. Mercury has a standard reduction potential within the electrochemical stability window of water (Hg₂²⁺_{(aq)}+2e⁻=2Hg_{(liq)}, E⁰=+0.599 V vs. Ag/AgCl and Hg²⁺_{(aq)}+2e⁻=Hg_{(liq)}, E⁰=+0.657 V vs. Ag/AgCl), enabling the electrodeposition of Hg²⁺ from contaminated aqueous solutions into metallic Hg on the surface of the electrode, as illustrated in FIG. 1B.

First, the effect of applied potentials on the removal efficiency of mercury with a background electrolyte of 20 mM KNO₃ is investigated, and a correlation between applied potential and the removal of mercury is observed, as shown in FIG. 3A. On P3HT-CNT/Ti coated electrodes at +0.25 V vs. Ag/AgCl, <20% removal efficiency is obtained at the initial concentration of 1 and 10 mg L⁻¹, but >60% removal is observed with 200 mg L⁻¹. Potentials lower than 0 V vs. Ag/AgCl result in the removal efficiency of >75% in the case of 1 mg L⁻¹ Hg(II) and >95% for 200 mg L⁻¹ Hg(II). On the other hand, there is no discernible decrease in the concentration of Hg(II) when electrochemical potential is not applied (open circuit, O.C.), indicating that the removal is electrochemically-driven. The mechanism of mercury removal is attributed to electroplating, considering the high reduction potential range of Hg, as discussed below. Upon prolonged charging of P3HT-CNT/Ti at −1.0 V vs. Ag/AgCl, as shown in FIG. 3B, the amount of electrodeposited mercury increases steadily with time, contrary to the control experiments in the absence of an applied potential. FIG. 3B shows fast electroplating kinetics, reaching >800 μg cm⁻² after 180 min.

To evaluate relevant environmental conditions, the performance of P3HT-CNT/Ti using 20 mM KNO₃ and real secondary effluent wastewater (collected from Urbana-Champaign Sanitary District), spiked with 85-90 ppb Hg²⁺, which is within environmental range of Hg-contaminated wastewaters, is investigated. Over 95% removal efficiency is achieved after 5 h deposition at −1.0 V vs. Ag/AgCl, satisfying the 6 ppb WHO standard for inorganic Hg in drinking water, as shown in FIG. 3C. This result provides evidence that electrical modulation of a P3HT-functionalized electrode enables efficient Hg remediation for real-world, practical applications.

Reversible Nature of Hg Deposition and Release on P3HT-CNT/Ti

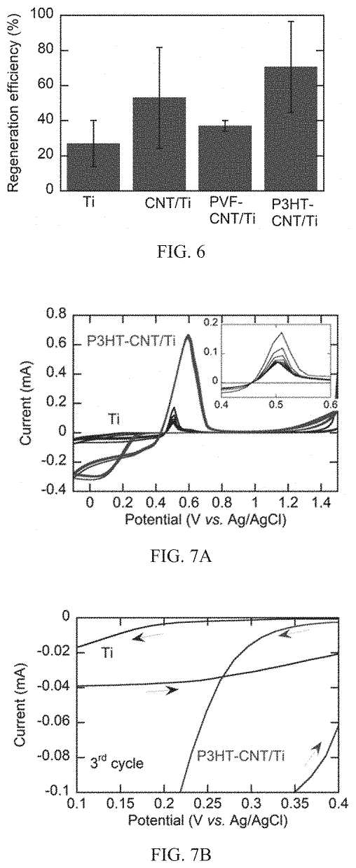

Here, the benefit of implementing P3HT-CNT/Ti as an electrode material is investigated by first charging the P3HT-CNT/Ti electrode in 200 mg L⁻¹ Hg(II)+20 mM KNO₃ at −1.0 V vs. Ag/AgCl during electrodeposition for 0.5 h, and then applying +1.5 V vs. Ag/AgCl for 0.5 h for releasing (stripping) deposited mercury into the 20 mM KNO₃ electrolyte. As depicted in FIG. 4, the release or regeneration efficiency (defined as the ratio of mercury recovered to deposited) is highest with P3HT-CNT/Ti and greater than 80% (specifically, 86.3% in this example) without the use of an acid or any other chemical additive. Release kinetics reveal that regeneration may be completed within 5 min upon charging with positive potential as shown in FIG. 5, demonstrating fast kinetics of stripping. On the other hand, referring again to FIG. 4, non-functionalized CNT/Ti or Ti mesh shows poorer regeneration, suggesting irreversible and/or slow nature anodic stripping. Hg stripping in strong acid (1.1 M HNO₃) with an applied potential shows the same trend in regeneration efficiency, as indicated in FIG. 6. This result suggests that the judicious selection of materials may enable not only efficient removal via electrodeposition, but also electrochemically-controlled release for cyclability.

The reversible nature of deposition and release of mercury on P3HT-CNT/Ti is also confirmed using scanning electron microscopy (SEM) and energy dispersive spectroscopy (EDS) analysis. High-resolution SEM images after electrodeposition show the presence of metallic mercury deposited on the P3HT-CNT/Ti coating upon application of a reducing potential, and EDS mapping confirms that the agglomerate formed on the P3HT-CNT/Ti surface includes Hg. SEM imaging of bare titanium electrodes after electrodeposition reveals metallic Hg with similar features to P3HT-CNT/Ti electrodes. Notably, after applying a positive potential for stripping, the regeneration of P3HT-CNT/Ti electrode is evidenced using SEM-EDS analysis, whereas a bare Ti mesh shows incomplete regeneration.

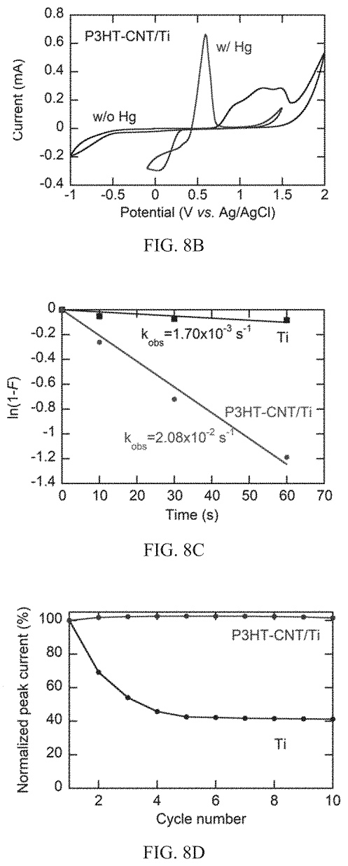

Cyclic voltammetry (CV) characterization is carried out to further investigate the reversibility of P3HT-CNT/Ti for capture and release of mercury compared to Ti as a control, as shown by the data in FIGS. 7A-7D and 8A-8D.

First, the background current of the Ti substrate in the potential range of −1.0 to +1.5 V vs. Ag/AgCl is low (|i|<0.05 mA cm⁻²) without the addition of Hg(II) in 20 mM KNO₃ (FIG. 7A), and no cathodic reaction, including hydrogen evolution, occurs in the cathodic scan up to −1.0 V vs. Ag/AgCl. On the other hand, the presence of 200 mg L⁻¹ Hg(II) brings about a cathodic current from <+0.20 V vs. Ag/AgCl (FIGS. 7A and 7C), which is attributed to the electrodeposition of Hg(II) from solution. However, in the following forward anodic scan, an oxidation peak is small or absent (FIGS. 7A and 7B), indicating irreversible nature of mercury electrodeposition and anodic stripping on Ti; only when the potential window of the cyclic voltammetry is narrowed to −0.1 to +1.5 V vs. Ag/AgCl, moderate deposition (with cathodic current of ca. −0.04 mA cm⁻² at −0.1 V) up to −0.1 V vs. Ag/AgCl results in the appearance of a small anodic peak (ca. 0.09 mA cm⁻²) (FIG. 7A). Electrochemical deposition of a metal ion on a foreign surface may require higher overpotential compared to deposition on the same metal because of crystallographic substrate-metal misfit. Therefore, deposition of Hg on foreign surfaces may necessitate a more negative potential value of the onset of electrodeposition (E_{nucleation}) compared with the redox potential of Hg(II)/Hg(0) (E_{eq}). On the other hand, in the anodic scan, the oxidation of Hg(0) to Hg(II) starts from a surface already coated with Hg, resulting in an onset potential of stripping close to the equilibrium potential of Hg(II)/Hg(0) (E_{eq}). This difference—between electrodeposition and stripping—creates an overpotential for nucleation (η_{nucleation}=E_{nucleation}−E_{eq}) and exhibits a crossover between the cathodic and anodic scan in cyclic voltammetry, which is indicative of the formation of nuclei on the electrode. In FIG. 7A, during the cathodic scan, no significant increase in current occurs until close to +0.2 V vs. Ag/AgCl is reached, which can be interpreted as an onset for nucleation, E_{nucleation}. On the reverse scan, the deposition proceeds on the existing Hg surface until E_{eq} is reached (0.46 V vs. Ag/AgCl, the crossover point in CV at zero current). After passing the E_{eq}, a peak corresponding to the oxidation of deposited Hg is exhibited, which denotes stripping. However, depending on the negative voltage limit of CV, sometimes no stripping peak is observed (FIG. 7B)). The irreversibility of Ti electrode may be associated with a native oxide layer on the surface of the substrate: this semiconducting layer may be responsible for high resistance against anodic stripping which may be larger than the resistance against cathodic deposition.

Referring now to FIGS. 8A and 8B, in the case of P3HT-CNT/Ti, the background current in the absence of Hg(II) exhibits a characteristic oxidation behavior of P3HT to P3HT⁺ with anion doping. This indicates a lower nucleation overpotential (η_{nucleation}) compared to the Ti electrode. Furthermore, given that the nucleation of Hg(II) may preferentially start on step edges and on surface defects, it is hypothesized that the more defect-rich P3HT-CNT/TI surface might facilitate Hg nucleation as compared to bare Ti, exhibiting a lower overpotential for the onset of the cathodic current.

The current at −1.0 V vs. Ag/AgCl is smaller with the P3HT-CNT/Ti electrode as compared to Ti, due to lower electrical conductivity of the P3HT-CNT/Ti composite compared to metals. This is in agreement with mercury removal performance at −1.0 V vs. Ag/AgCl with Ti and P3HT-CNT/Ti; the removal efficiency at −1.0 V vs. Ag/AgCl is higher with Ti compared to P3HT. Nevertheless, though capturing a smaller amount of metallic mercury on its surface, P3HT-CNT/Ti shows a significantly larger anodic peak (FIG. 8B), which may be interpreted as the oxidation of the electroplated mercury. Also, the change in the potential window of the cyclic voltammetry does not alter the behavior—reversible reduction and oxidation peak are preserved no matter what potential range is used. All these electrochemical characterizations are in agreement with the deposition/stripping efficiency and SEM-EDS analysis discussed above, and demonstrate that P3HT-CNT/Ti enables reversible oxidation of metallic mercury, as compared to bare Ti, which is able to plate mercury but not to release it. The reversibility may be attributable to the synergistic electrocatalytic properties of P3HT-CNT/Ti in the redox of Hg(II)/Hg(0). In fact, it is shown that P3HT-CNT/Ti enables enhancement of the electrochemical response. P3HT is nonconducting in the neutral state and becomes conductive when oxidized because of the delocalization of electrons along the polymer backbone, thereby exhibiting a so-called valve-effect that causes resistance against anodic stripping to be much lower than the resistance against cathodic deposition. XPS analysis confirms that for higher applied potentials, i.e. during stripping, the percentage of oxidized P3HT increases; this behavior is observed both in non-acid and acid electrolytes.

In addition, P3HT-CNT/Ti not only improves the reversibility of the adsorbent by enhancing the release of the deposited mercury, but also exhibits higher performance stability upon oxidation and reduction over a number of cycles. As shown in FIG. 8D, peak current density for 10 cycles (normalized by the peak current at the first cycle) does not decrease, implying stable, reversible mercury capture and release enabled by P3HT. On the other hand, not only does Ti have very small electrochemical activity for the stripping of deposited Hg, but it also shows decreasing peak current over 10 cycles, with its irreversibility being serious (the anodic peak current drops to 40% of the first cycle value), again confirming the role of P3HT-CNT/Ti as a promising interface with high electrocatalytic activity and reversibility.

In-Situ Optical Microscopy

In-situ optical microscopy (in-situ OM) is employed enable the direct observation of mercury electrodeposition on the polymer films and changes in morphology under electrochemical response. Applying a cell voltage of 2 V (two-electrode electrochemical cell) reveals the formation of a uniform film on the P3HT-CNT/Ti coated electrode, which is attributed to the deposition of mercury. In contrast to indirect ex-situ techniques, in-situ OM does not itself interfere with the deposition morphology of Hg, thereby enabling the study of surface behavior and mechanism during a cycle of deposition and stripping. Stripping of deposited mercury occurs on the same time-scale, which is possible due to fast stripping activity on the P3HT-CNT/Ti surface (e.g., see FIG. 8B); reversing polarity and applying 2 V allows for release of the Hg film rapidly in the same Hg-containing solution and recovering the regenerated surface of P3HT-CNT/Ti. Focusing at the edge of the polymer, the film appears to include small mercury particles that are completely dissolved during stripping, as can be seen via in-situ OM. This is direct evidence of the fast plating and stripping when using P3HT-CNT/Ti in a non-acid medium. In comparison, bare titanium electrodes display incomplete stripping of the electroplated Hg. Even more, in-situ OM results provide insight on how Hg distribution and morphology changes as the electrode is dried; drying the P3HT-CNT/Ti electrode in the air appears to cause coalescence of the deposited Hg into droplets of bigger size. The ability of the Hg particles to easily diffuse on the P3HT-CNT/Ti surface might be indicative of a weaker coating-mercury interaction.

Energy Consumption Analysis

Finally, the energy consumption for the working electrode half-cell reaction during electrodeposition as well as stripping is estimated. The following equation is used:

$$SE = \frac{{\int }_{0}^{t} E ( t ) i ( t ) d t}{{m}_{H g}} \qquad ( 1 )$$

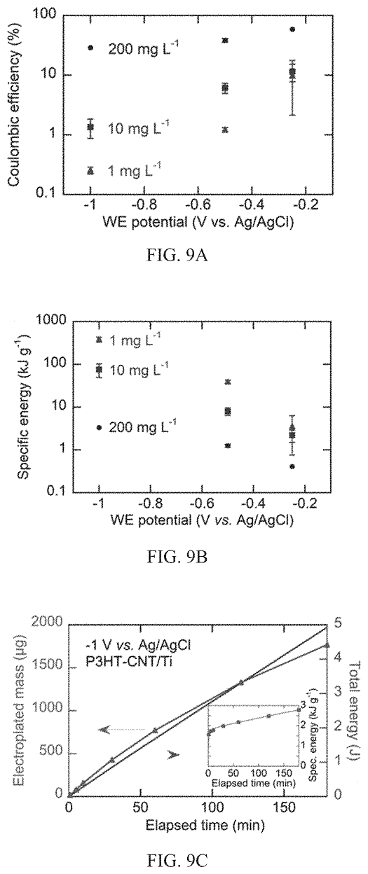

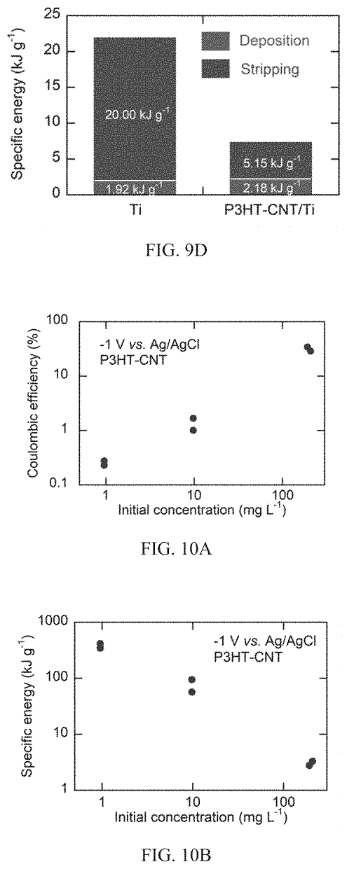

Equation (1) estimates the specific energy (SE; kJ g⁻¹) by integrating the product of the potential E(t) by the current i(t) over the duration of the electrochemical deposition (stripping) and dividing it by the deposited (stripped) Hg mass mH_{g}; giving the energy consumed by the working electrode half-cell during electrodeposition or stripping. For deposition, Hg(II) concentration and applied potential affect both the Coulombic efficiency (FIG. 9A) and the specific energy (FIG. 9B) during electrodeposition. At higher overpotentials (e.g., at −1 V vs. Ag/AgCl) electrodeposition is more energy intensive and has lower Coulombic efficiency, while at lower overpotentials (e.g., at −0.25 V vs. Ag/AgCl) removing Hg is more efficient and requires a much lower energy consumption. At higher Hg(II) concentrations, Coulombic efficiency is improved and specific energy is lower, as displayed in FIGS. 10A and 10B for P3HT-CNT/Ti in the case of −1 V vs. Ag/AgCl. Notably, P3HT-CNT/Ti is more efficient than bare titanium during Hg stripping; FIG. 9D shows that although at −1.0 V vs. Ag/AgCl P3HT-CNT/Ti coated electrodes consume −14% more energy as compared to bare titanium electrodes when electrodepositing Hg, which is in line with the less conductive nature of neutral P3HT-CNT/Ti (2.18 kJ g⁻¹ for P3HT-CNT/Ti vs. 1.92 kJ g⁻¹ for Ti), there is a 74% lowering of the energy consumption during the subsequent stripping at +2.0 V vs. Ag/AgCl (5.15 kJ g⁻¹ for P3HT-CNT/Ti vs. 20.0 kJ g⁻¹ for Ti), further confirming that judicious selection of material enables energy-efficient removal of Hg. P3HT-CNT/Ti electrodes exhibit a 3-fold improvement in total energy efficiency compared to Ti (7.33 kJ g⁻¹ for P3HT-CHT/Ti vs 21.92 kJ g⁻¹ for Ti). In the 3 h electrodeposition kinetics on P3HT-CNT/Ti in 200 mg L⁻¹ Hg(II) at −1 V vs. Ag/AgCl, the specific energy as a function of time is estimated as the ratio of the total energy to the electroplated mass. The specific energy of P3HT-coated electrodes slightly increases over time (1.6-2.8 kJ g⁻¹ range), indicating the importance to control the duration in practice (FIG. 9C, inset), yet still shows lower specific energy compared to Ti (˜6.5 kJ g⁻¹). These results further confirm that P3HT-CNT/Ti not only allows reversible uptake and release of Hg, but also provides an energy-efficient option for electrochemical Hg remediation.

Experimental Details

Preparation of P3HT-CNT/Ti electrodes: Solution A was prepared by mixing P3HT (16 mg) (regioregular electronic grade, Rieke Metals) with CNT (8 mg) (multiwalled carbon nanotubes, Sigma-Aldrich) in chloroform (2 mL) and then sonicated for 30 min in icy water. Solution B was prepared by mixing CNT (8 mg) in chloroform (2 mL) followed by 30 min sonication in icy water. Solution B was then poured in solution A and further sonicated for 30 min in icy water; this solution is referred as P3HT-CNT/Ti. Titanium grade 1 mesh (Titanium screen, Fuel Cell Store) rectangles (1 cm×2 cm, 53 μm thick) were cut and coated with P3HT-CNT/Ti via dip coating. The dipped area was approximately 2 cm² and after each dip the solvent was given enough time to evaporate before a new dip took place. CNT/Ti electrodes were prepared in the same way, using solutions with a CNT concentration of 4 mg mL⁻¹ in chloroform and by sonicating 60 min in icy water. The polymer coated electrodes were then secured to a copper wire using copper foil tape. Poly(vinyl)ferrocene (Polyscience)-carbon nanotube composite on Ti mesh (PVF-CNT/Ti) electrodes were prepared in the same way as P3HT-CNT/Ti electrodes.

Hg capture and release experiments: Hg(II) solutions with Hg concentrations of 1 mg L⁻¹, 10 mg L⁻¹, 200 mg L⁻¹+20 mM KNO_{B} were prepared by mixing Hg(NO₃)₂ (puriss p.a., ACS reagent, 83381-50G, Sigma-Aldrich) and KNO3 (Sigma-Aldrich) in DI-water. The potentiostat used were VersaSTAT 4 Potentiostat Galvanostat (Princeton Applied Research) and BioLogic. A 3-electrodes setup electrochemical cell was used, with Ag/AgCl (3 M NaCl) reference electrode (RE-5B Ag/AgCl, BASi) and a platinum wire counter electrode. Electrodeposition and stripping experiments were run in a 20 mL glass vial with 5 mL solution with magnetic stirring (300 rpm). Electrodeposition kinetics was run with 15 mL of solution. When applying voltages >+0.2 V vs. Ag/AgCl, a custom-made confinement for the CE (consisting in a pipette tip with a glass frit) minimized the plating of Hg on the CE. ICP-OES (5110 ICP-OES, Agilent Technologies) allowed to determine the Hg concentration of the solutions. The viewing mode was axial, 10 replicates were run and the wavelengths 184.887 nm, 194.164 nm and 253.652 nm were measured, using the 194.164 nm for the removal and regeneration efficiency calculations. Rinse time was 90 s with a 1.1 M HNO₃+1 mg L⁻¹AuCl₃ rinse solution, while all the dilutions were prepared with 1.1 M HNO₃+5 mg L⁻¹AuCl₃. This setup allowed to limit the memory effect of Hg.

Hg stripping kinetics: The observed reaction rate constant (k_{obs}) was estimated from the slope of the Hg⁰ oxidation vs. time curve using the following equation:

ln(1−F)=−k_{obs}·t (2)

where F=Cₜ/C_{∞}; Cₜ is the amount of stripped Hg cation at time t, C_{∞} is the amount of deposited Hg.

Materials characterization: Surface morphologies and elemental mapping images of the electrodes were obtained using a scanning electron microscope (SEM; Hitachi S-4700 and JSM-7000F) operated at an accelerating voltage in the 10-20 kV range, equipped with energy dispersive X-ray spectroscopy (EDS; iXRF) with the accelerating voltage in the 15-20 kV range and 30° take-off angle. The amount of oxidized P3HT was estimated using X-ray photoelectron spectroscopy (XPS; Kratos Axis ULTRA) with monochromatic Al Kα X-ray source (210 W). The XPS results were analyzed using CASA XPS software (UIUC license). Binding energies were corrected to the alkyl C 1s feature at 284.6 eV. S 2p spectra were fitted with 100% Gaussian peaks with linear baseline correction.

In situ optical microscoy observation: Direct observation of the mercury deposition and stripping process was performed using a liquid-confining cell. The cell was made using a glass slide, silicon elastomer films, and a cover glass. Ti mesh electrode with and without P3HT coating was cut to a small strip and used as the working electrode. An aluminum strip was used as the counter electrode. These electrode strips were sandwiched between the two elastomer films with square window and placed on a glass slide. The cell was filled with the same electrolyte solution used in the Hg capture and release experiments, and the top was closed with a cover glass for the optical microscope observation. The potentiostat used in the experiments was Metrohm Autolab PGSTAT101.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A working electrode for the electrochemical remediation of a metal species, the working electrode comprising:
a conductive substrate; and
a polymeric coating comprising a semiconducting or redox-active polymer on the conductive substrate.

2. The working electrode of claim 1, wherein the polymeric coating further comprises a conductive additive.

3. The working electrode of claim 2, wherein the conductive additive comprises carbon particles and/or carbon nanotubes.

4. The working electrode of claim 1, wherein the semiconducting or redox-active polymer is selected from the group consisting of: poly(3-hexylthiophene-2,5-diyl) (P3HT), poly(vinyl)ferrocene (PVF), poly-TEMPO-methacrylate (PTMA), polyaniline (PANI), poly(3,4-ethylenedioxy thiophene) (PEDOT), polythiophene (PT), poly(3,4-propylenedioxy thiophene) (PProDOT), PEDOT:poly(4-styrene sulfonate) (PEDOT:PSS), polypyrrole (PPy), polyacetylene (PA), poly(indole) (PI), and poly(p-phenylene) (P-p-P).

5. The working electrode of claim 1, wherein the conductive substrate comprises titanium, stainless steel, or conductive carbon.

6. The working electrode of claim 1, wherein the conductive substrate comprises a mesh or a felt.

7. A system for the electrochemical remediation of a metal species, the system comprising:
an electrochemical cell comprising:
the working electrode of claim 1; and
a counter electrode spaced apart from the working electrode;
a power supply electrically connected to the working and counter electrodes; and
a pump for flowing a contaminated solution and then a recovery solution through the electrochemical cell.

8. The system of claim 7, wherein the electrochemical cell further comprises a membrane between the working electrode and the counter electrode.

9. The system of claim 7, wherein the counter electrode comprises a metal, carbon, crystalline material, and/or a polymer.

10. The system of claim 7, wherein the electrochemical cell comprises multiple pairs of the working electrode and the counter electrode arranged in a stack.

11. A method for the electrochemical remediation of a metal species, the method comprising:
flowing a contaminated solution comprising a metal species to be removed through an electrochemical cell comprising a working electrode and a counter electrode spaced apart from the working electrode, the working electrode comprising a current collector with a polymeric coating thereon, the polymeric coating comprising a semiconducting or redox-active polymer;
applying a reducing potential to the electrochemical cell, thereby inducing the metal species from the contaminated solution to deposit onto the working electrode;
after depositing the metal species, flowing a recovery solution through the electrochemical cell; and
applying an oxidizing potential to the electrochemical cell, thereby stripping the metal species from the working electrode and recovering the metal species in the recovery solution.

12. The method of claim 11, wherein the metal species is selected from the group consisting of: Ag, Al, Au, Cd, Cu, Fe, Hg, Mg, Ni, Pb, Pt, Sn, and Zn.

13. The method of claim 11, wherein the semiconducting or redox-active polymer is selected from the group consisting of: poly(3-hexylthiophene-2,5-diyl) (P3HT), poly(vinyl)ferrocene (PVF), poly-TEMPO-methacrylate (PTMA), polyaniline (PANI), poly(3,4-ethylenedioxy thiophene) (PEDOT), polythiophene (PT), poly(3,4-propylenedioxy thiophene) (PProDOT), PEDOT:poly(4-styrene sulfonate) (PEDOT:PSS), polypyrrole (PPy), polyacetylene (PA), poly(indole) (PI), and poly(p-phenylene) (P-p-P), and
wherein the conductive substrate comprises titanium, stainless steel, or conductive carbon.

14. The method of claim 11, wherein the polymeric coating further comprises a conductive additive.

15. The method of claim 14, wherein the conductive additive comprises carbon particles and/or carbon nanotubes.

16. The method of claim 11, wherein the reducing potential is −0.2 V vs. Ag/AgCl or less, and
wherein the oxidizing potential is at least about +0.4 V vs. Ag/AgCl.

17. The method of claim 11, wherein at least about 96% of the metal species in the contaminated solution is deposited onto the working electrode, corresponding to a removal efficiency of at least about 96%.

18. The method of claim 11, wherein at least about 80% of the metal species deposited on the working electrode is released in the recovery solution, corresponding to a release efficiency of at least about 80%.

19. The method of claim 11, wherein, after applying the reducing potential and depositing the metal species on the working electrode, the contaminated solution contains the metal species at a concentration of less than 6 μg L⁻¹.

20. The method of claim 11, wherein the recovery solution does not include an acid.
